(19) United States
(12) Patent Application Publication
(10) Pub. No.: US 2019/0188658 A1
(43) Pub. Date: Jun. 20, 2019

(54) SYSTEM AND METHOD FOR USER-DIRECTED DONATIONS

(71) Applicants: Anthony Largura, Orlando, FL (US); Christopher Chan, Winter Garden, FL (US); Andrew Sheeter, Windermere, FL (US)

(72) Inventors: Anthony Largura, Orlando, FL (US); Christopher Chan, Winter Garden, FL (US); Andrew Sheeter, Windermere, FL (US)

(21) Appl. No.: 15/845,100

(22) Filed: Dec. 18, 2017

(51) Int. Cl. G06Q 20/08; G06Q 30/02; G06Q 20/22; G06Q 40/00

(52) U.S. Cl. CPC G06Q 20/085; G06Q 30/0279; G06Q 20/382; G06Q 40/123; G06Q 20/223

(57) ABSTRACT

Embodiments described herein provide for a system and method for user-directed donations over a network. Each user within the network selects a plurality of charities to donate monetary differences from transactions on a financial statement. The user may select specific percentages of each monetary difference to be directed to user-specified charities.

### FIELD

The present invention generally relates a system for receiving, sending, and generating crowdfunding and directing funds to predetermined recipients.

### BACKGROUND

Online communities have become a powerful means for distributing ideas, money, and knowledge. The advantage of such communities is they are no longer restrained by space, as the internet allows users to connect with others all over the world. Businesses have taken advantage of this as they are no longer constrained to clients in a specific geographic area.

Charities and other donation recipients have also taken advantage of the internet and have vastly increased their reach. This increase typically comes from the promotion of the charity, and a simple request for donations. While this strategy does work, the increasing use of the internet may lend itself to new strategies that were impossible until recent.

Applications exist which allow users to save a predetermined amount of funds for each transaction. These applications are used to help users save money, namely, by rounding up to the next dollar for each transaction made. For example, if a user spends $10.50 at a department store, the application charges an additional 50 cents and sends that amount to their savings account. Of course over time this results in a large savings that otherwise would have been difficult to obtain.

Many citizens donate to charities. It is a common strategy to donate in a single lump sum periodically, such as quarterly. This can be difficult for some as paying a large amount all at once creates financial strain. A similar method for donations may be applied to the savings example above. It can be seen that an advancement in the arts of donations is warranted. One such advance is described by embodiments herein.

U.S. Pat. App. No. 2016/0267601 to Parikshit Om Kundu discloses an internet-based, user-controlled aspirational saving social network system as well as a method for end-to-end articulation, savings, and fulfillment of user's aspirations. This system is meant to bridge the gap between the user's savings account, and the actual purpose for their savings. User's may connect with others having similar aspirations, access savings tools, and access a platform designed to maximize monetary amounts. The application fails to address crowdfunding functionalities or capabilities leaving room for advances in the arts.

U.S. Pat. App. No. 2016/0110776 to Givling, Inc. discloses a system and method for gamified crowdfunding over the Internet in order to crowdfund worthy or charitable causes while also offering incentives and rewards. This is presented in the form of an entertaining game as well as a potential share of the proceeds therefrom. The user may select a beneficiary as well as a specific game to be played. This game is then accessed by user's throughout the network and funds are collected and distributed.

U.S. Pat. App. No. 2014/0278861 to 4Me 4We, Inc. discloses a method and system for user-directed donations from a company to a charity in which an affiliate company agrees to donate a percentage of each transaction with a registered user. One or more charities may be selected as well as a percentage to donate. A personal payment account is used to generate the transaction such that the user may conduct business and generate donations so long as the business is an affiliate of the system. This application fails to disclose any crowdfunding component which may drive further funds to beneficiaries.

U.S. Pat. App. No. 2013/0030889 to PayPerks, Inc. discloses a system and method for providing a rewards program for a plurality of rewards accounts that promote adoption, retention, and desirable usage of credit cards, prepaid cards, debit cards, and other transactional products. Embodiments of the invention provide for rewards dependent on varying parameters.

U.S. Pat. No. 2016/0203526 to Andra Tomsa discloses a system and method for collecting microdonations by scanning and documenting the contents of a receipt. The system then calculates the remainder between the charged amount and the next integer amount and facilitates the transfer of this remainder to a user-determined recipient. The system may also calculate the remainder using an application without utilizing a receipt.

### SUMMARY OF THE INVENTION

Embodiments described herein provide for a system and method for a user-directed donations across a network. The system has a processor, a graphical user interface, and at least one storage device. The processor communicates with the storage device and user interface to execute a series of instructions. These instructions may include registering a user account, associating the user account with a user, linking a user financial account with a user account, calculating a monetary value for a transaction in the user financial account, calculating a monetary difference between the monetary value and the next largest whole integer amount, sending the monetary difference to a user-specific charity financial account, associating the monetary difference with a user account, and adding the monetary difference to a balance in a user account.

The user may select from a plurality of recipients to direct money to specific charities of their choice as well as select a percentage of each monetary difference to send to each charity. Donations are sent out at predetermined time intervals, such as monthly. Users are permitted to set maximum and minimum donation amounts for a specified time interval. Any setting is able to be modified by the user at any time.

In an embodiment, the user may elect to send single lump sum donations rather than send monetary differences as donations throughout the month.

A social network displays donations amounts by the user, as well as the amount of donations received by charities on the graphical user interface.

In an embodiment, the network provides tax summaries to the user.

A method is disclosed for user-directed donations, the method includes the steps of receiving a plurality of charities and donation percentages to be sent thereto as selected by the user. Settings are stored by a storage device and may be modified at anytime by the user. As financial transactions are tracked by a transaction tracking module, the donation tracking module directs donations to user-specified charities. Each donations sum is associated with the user account and displayed on the graphical user interface.

A user account module and charity account module permit the registration and modification of accounts.

Other aspects, advantages, and novel features of the embodiments will become apparent from the following detailed description in conjunction with the figures.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 is a flowchart of a user directed donation method, according to an embodiment of the present invention;

FIG. 2 is a block diagram of user directed donation system, according to an embodiment of the present invention;

FIG. 3 illustrates a schematic representation of a screenshot of a network-based user-directed donations system, according to an embodiment of the present invention;

FIG. 4 illustrates a schematic representation of a screenshot of a network-based user-directed donations system, according to an embodiment of the present invention;

FIG. 5 illustrates a schematic representation of a screenshot of a network-based user-directed donations system, according to an embodiment of the present invention;

FIG. 6 illustrates a schematic representation of a screenshot of a network-based user-directed donations system, according to an embodiment of the present invention;

FIG. 7 illustrates a schematic representation of a screenshot of a network-based user-directed donations system, according to an embodiment of the present invention;

FIG. 8 illustrates a schematic representation of a screenshot of a network-based user-directed donations system, according to an embodiment of the present invention;

FIG. 9 illustrates a schematic representation of a screenshot of a network-based user-directed donations system, according to an embodiment of the present invention;

FIG. 10 illustrates a schematic representation of a screenshot of a network-based user-directed donations system, according to an embodiment of the present invention;

FIG. 11 illustrates a schematic representation of a screenshot of a network-based user-directed donations system, according to an embodiment of the present invention;

FIG. 12 illustrates a schematic representation of a screenshot of a network-based user-directed donations system, according to an embodiment of the present invention;

FIG. 13 illustrates a schematic representation of a screenshot of a network-based user-directed donations system, according to an embodiment of the present invention; and

FIG. 14 illustrates a schematic representation of a screenshot of a network-based user-directed donations system, according to an embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

In general, the invention described herein relates to a system for allowing donors to link their bank account to a mobile application and send charitable donations to user-specified recipients. As purchases are made, donations are made at predetermined, or purchase-determined amounts to one or more affiliates of the user's choice. In embodiments, users—in this case the donors—may choose to either round-up their purchases to the next integer amount, effectively donating the difference between the integer and the purchase amount. Further, the user may elect to donate a lump sum. Various user settings such as payout times and amounts may be modulated by the user, allowing for different donation payment options for convenience.

In an embodiment, users, businesses, charities, and other individuals may interact with the interface through a personal electronic device (“PED”) which may include a PDA, laptop or desktop computer, smartphone, tablet, or similar PED having network connectivity enabled.

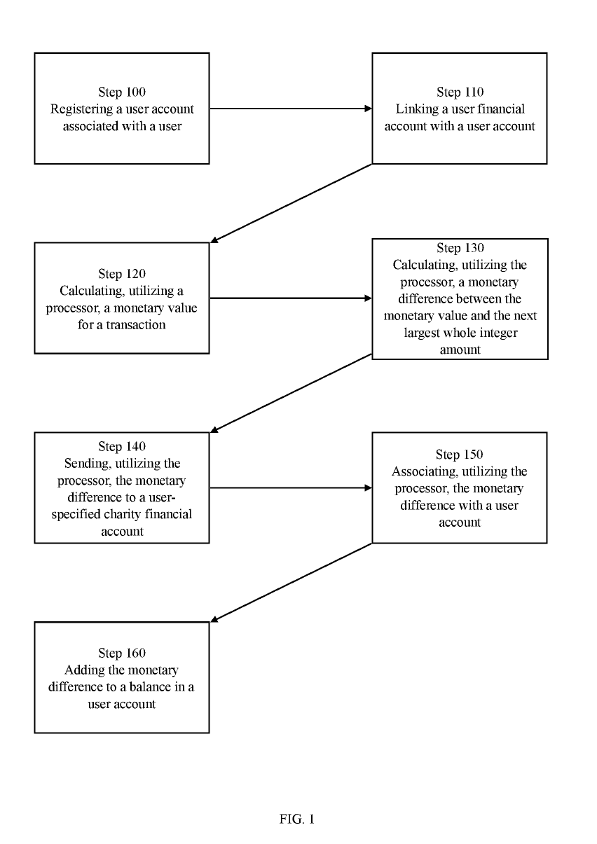

Referring now to FIG. 1, a block diagram illustrating a method is illustrated. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which executive via the processor of the computer or other programmable data processing apparatus, implements the functions/act specified in the block diagrams or operations block or blocks.

In alternate embodiments, the functions and acts noted in the blocks may be implemented in a modified order, such as substantially concurrently. Flowcharts illustrated are to provide a better understanding of the disclosure herein.

As illustrated in FIG. 1, an overview of an embodiment of the method is illustrated. In step 100, a user registers an account to be associated with a user. The user may be an individual who wishes to donate to a plurality of charities, or a charity whom will receive charitable donations. The account which is created by the user is utilized to engage with the graphical user interface (“GUI”) permitting users to interact with one another. This may include donors finding charities to selectively donate to, as well as charities interacting with donors. User may also engage in social activities, whether they are a donor or charity. In step 110, the user links a financial account, such as a bank account, to their profile account. The financial account is necessary as the invention utilizes the financial statement of the user in order to determine the amount which is donated to the plurality of specified charities. In step 120, a processor calculates a monetary value from a transaction made on the financial statement on the user financial account. In an embodiment, step 120 is performed by a processor for each transaction on the financial statement on the financial account through a given time period, such as the monthly statement. Each monetary value is summed to reach the total donation amount for the month.

In step 130, the processor calculates the monetary difference between the monetary value and the next largest whole dollar amount. Step 130, along with step 120 is performed throughout each transaction in the financial statement. In an embodiment, step 130 is performed once the financial statement is complete, such as on a monthly basis. In an alternate embodiment, step 130 is performed after each financial transaction as it occurs on the financial statement permitting an accurate total donation to be taken in real-time.

In step 140, monetary difference is sent by the processor to a designated financial account or plurality of financial accounts as selected by the user. In preferred embodiment, the user may select up to five charities to donate to at a selected percentage. For example, the user may elect to donate equal monetary amounts to each of five charities. The amount donated to each charity may be selected in account settings.

In step 150, the processor associates the monetary difference to be donated with a specific user account, thus adding the monetary difference to a balance. The balance may then be directly taken to or from the linked financial account of the user. Balances may be viewed throughout the network on the user's profile. The balance may be amount donated by a donor, or amount received by a charity throughout a specified period of time.

In step 160, the processor determines a proportion of the total balance to send to each of the plurality of charities.

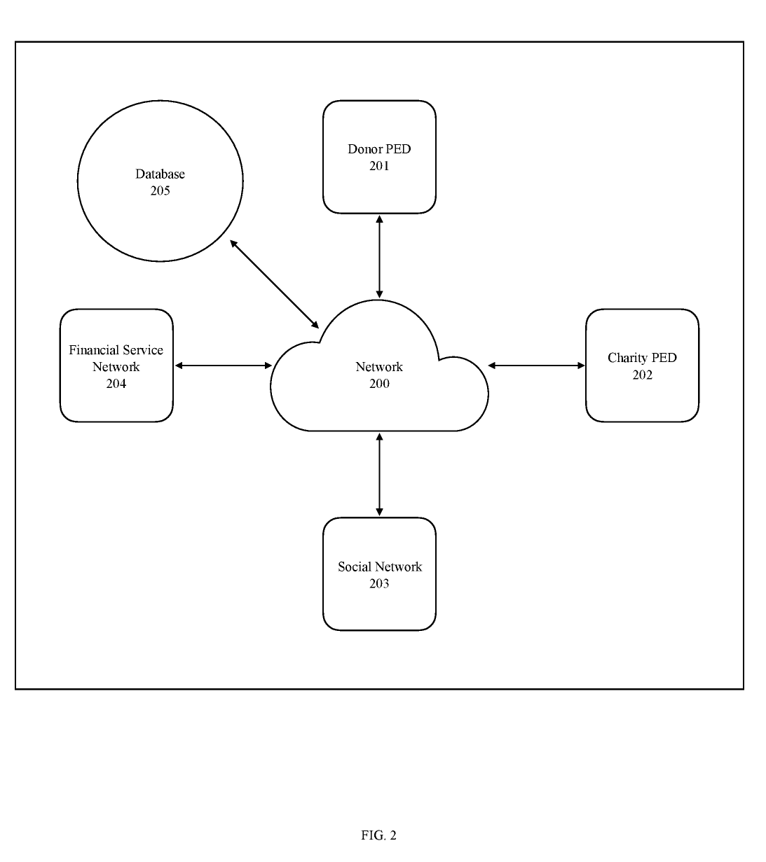

FIG. 2 illustrates a network configuration in an embodiment of the present invention. Network 200 is in communication with a user PED 201, a charity user PED 202, a financial services network 203, and a social network 204. Each device within the network may send and receive information. A database 205 may store information as well as send and receive information throughout the network 200.

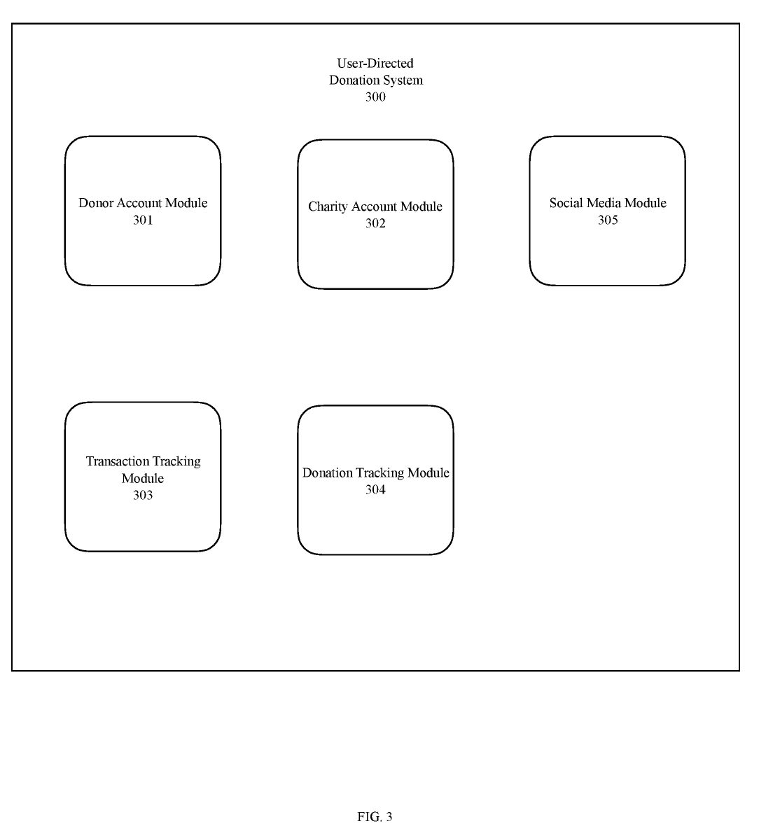

In an embodiment, the steps performed in FIG. 1 are performed by plurality of modules, embodiments of which are illustrated in FIG. 3. The user-directed donation system 300, in an embodiment, comprises a user account module 301, charity account module 302, transaction tracking module 303, donation module 304, and social media module 305 are in communication with one or more processors in order to execute functionalities of the invention.

In a preferred embodiment, the user account module 301 and charity account module 302 communicates with the user's PED 201 allowing for registration, donations, social networking, and other functionalities associated with the system 300. The transaction tracking module 303 is in communication with the financial network and received transaction data regarding user transactions. The donation tracking module 304 identifies a charity which the donation is directed towards and associates the appropriate charity with the appropriate user whom donated funds. The donation tracking module 304 may also apportion the user-specified percentage for each donation to the user-specified charity.

The system promotes user to user interactions as a means of promoting charitable donations throughout the network. Whether the user is a donor, or a charity, profiles are viewable throughout the network as determined by user privacy settings standard in the arts.

Throughout the specification, a charity is defined as a user, or group of users who receive funds or benefits in the network. These charities may be defined as an individual, a business, or any other beneficiary. In the embodiment wherein a business or group organization is the charity, a single administrator may be able to modify the account.

The donations system may interact with a social network such that the social network may automatically, with user permission, post a message or other notification regarding the transaction. In this manner, other users, campaigns, businesses and individuals may see the donation activity of the user. The intention of the social network is to promote further donations from user's both within and outside of the network.

In an embodiment, the system utilizes bank level security for any transactions made through the network. This may include ACH bank transfers such that credit cards or other payment credentials are securely input into the network. Further, SSL encryption using high-grade 256 bit encryption aids in promoting security of the app. It is a goal of the application to ensure PCI compliance throughout the system in order to ensure the highest level of security is utilized.

Affiliates may include charities, aid organizations, donation centers, and other beneficiaries both public and private.

To access and begin utilizing the network, a registration engine may be utilized to create an account. Once activated, the user may user their PED to access the graphical user interface by inputting credentials including a username, password, or similar implements. Once credentials are validated, any number of selectable panels, or graphical displays may be illustrated, each having specific account information related to the user, or other users in the network.

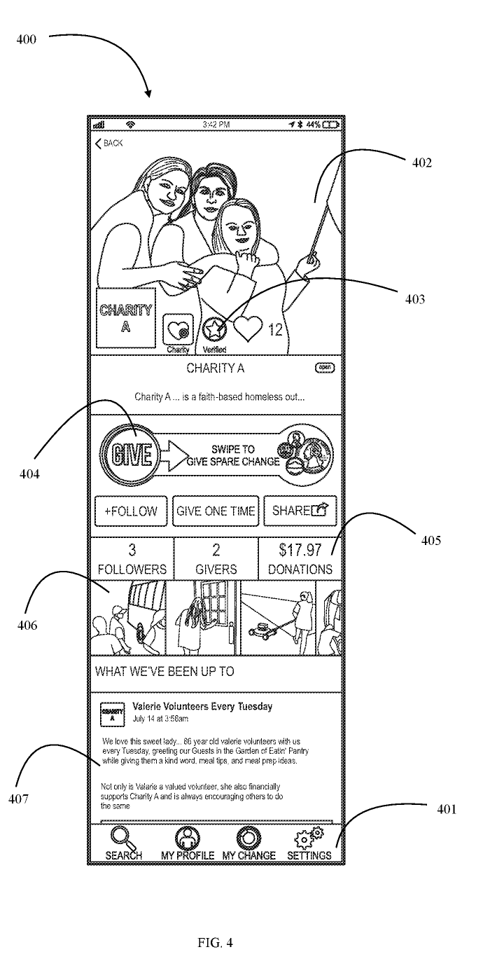

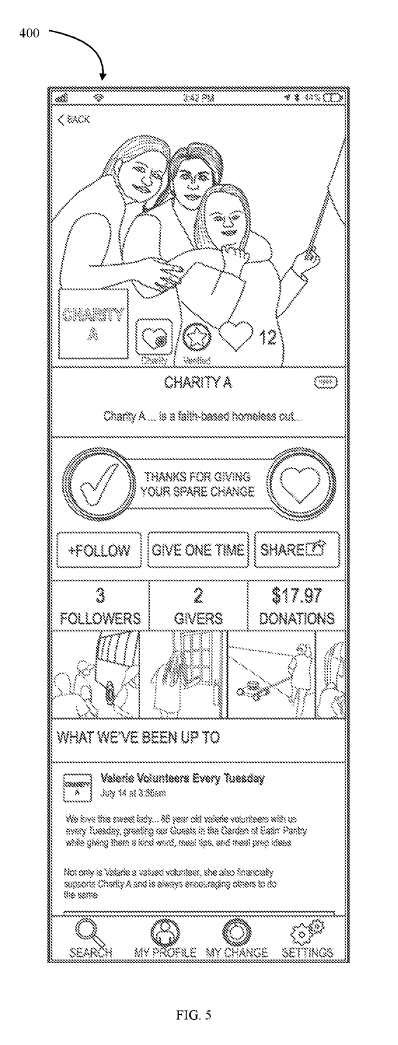

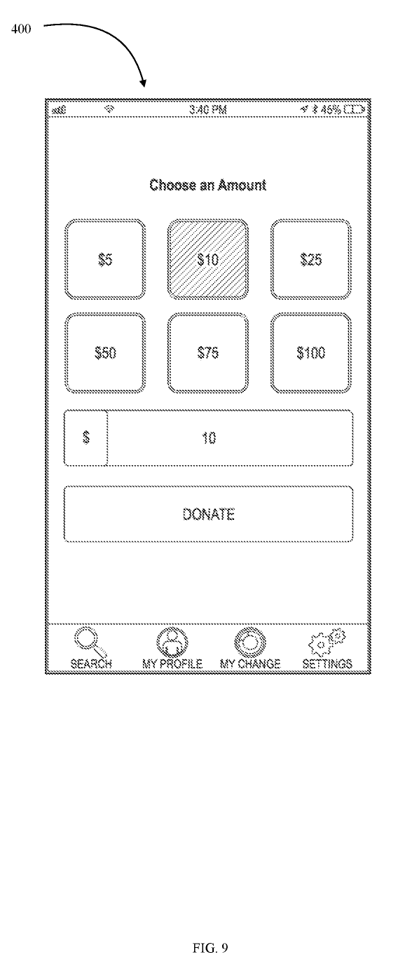

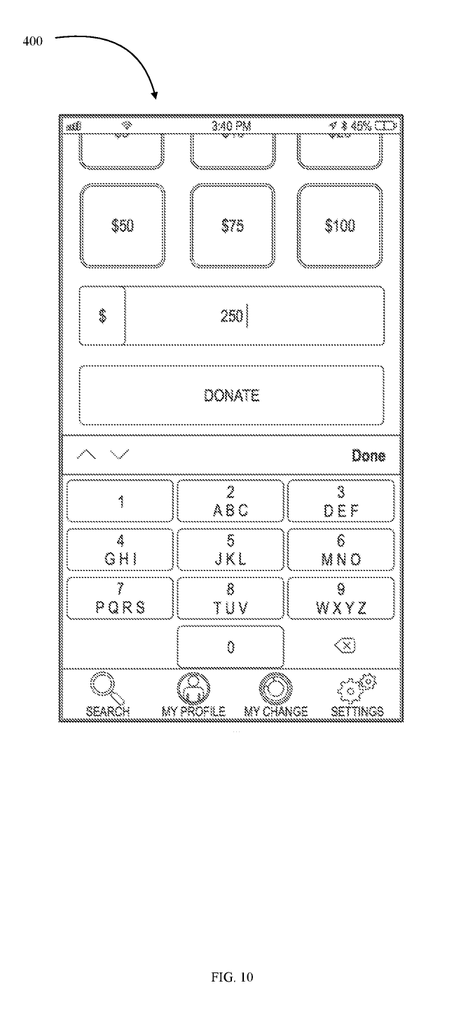

Users may interact with the network by utilizing a graphic user interface (“GUI”) 400. An embodiment of the GUI is illustrated in FIGS. 4-12. In specific reference to FIG. 4 and FIG. 5, a profile 402 for a charity is illustrated. The charity may input a description of their organization, including beneficiaries thereof and locations as well as any other desirable information. This may be accompanied by an image. If the charity has undergone a verification process, a verification icon 403 may be displayed.

In an embodiment, the system will provide a user with a action tab bar 401 substantially near the bottom of the user interface which aids the user to navigate through the system. The user may see the charity, and profiles thereof including pertinent information regarding the charity. The user may have the option to link external social media accounts as known in the arts.

In an embodiment, a donor may search and select to view specific charity profiles as seen in FIGS. 4-5. The user may then elect to donate to the charity, using a “GIVE” button 404 or similar donation implement. Once a donation has been sent, the GUI 400 may confirm the donation. In embodiments, the user may elect to follow the charity and thereon receive updates, donations opportunities, and other information posted in the network by the charity. Further, the user may elect to give one time or set up recurring payments. The user may also “SHARE” the charity profile to their network feed 406 for others to view, thus promoting charitable donations throughout the network. Further, the charity may post events and news in an information section 407.

In an embodiment, profile statistics are illustrated in a metrics section 405 including number of followers, number of donors, and amount of donations among other metrics commonly associated with charitable donations.

In an embodiment, the charity may post images or descriptions of their charity in the network feed 406. This may include recent activities related to the charity. Posts will be seen as determined by the settings input by the user. This may allow for the charity to post for the entire network to view, or constraints may be set to only permit specific users or groups of users to view the post. In further embodiments, events are illustrated such that users may see what events are upcoming.

In the GUI, the user may elect a number of actions to be performed including searching, view profile, view change, and settings positioned on the action bar 401. Each action may be elected by selecting a tab leading to an action page. Language used for the action bar 401 may include WIRE code or an equivalent language. The action bar may include selections including <Search> <My Profile> My Change> and <Settings>.

In an embodiment, an administrator of the network can verify the charity to ensure legitimacy.

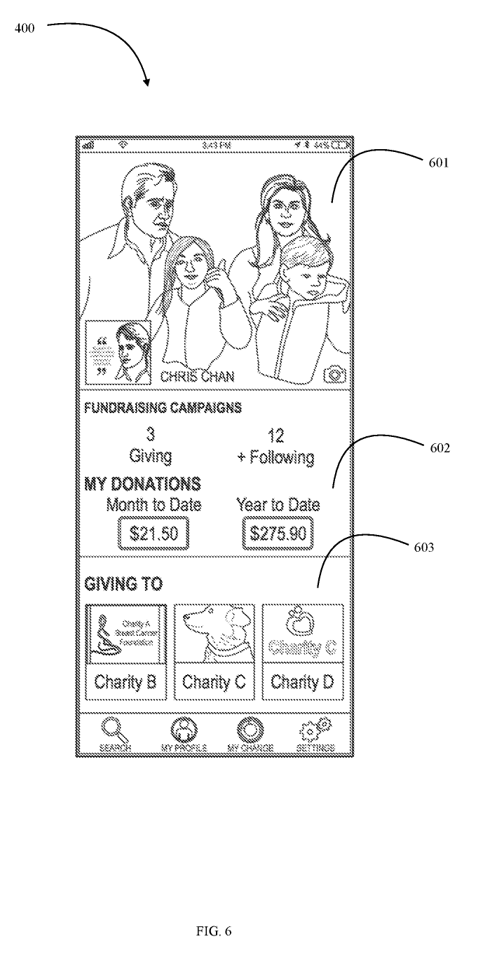

Now referring to FIG. 6, an embodiment of a donor profile is illustrated. In an embodiment, the user's profile is displayed either in private, or throughout the network as determined by user settings. The user may elect to input an image and text of their choosing. Campaign statistics such as number of followers, donations, and number of charities which the user gives donations to may be displayed in a donor metrics section 602 and a charity queue section 603.

In an embodiment, donations are totaled and displayed. Donation amounts may be by a predetermined period of time, such as by the day, week, month, year, or an indefinite total. Further, specific charities may be noted allowing others in the network to see where funds are being directed in order to promote widespread charitable giving.

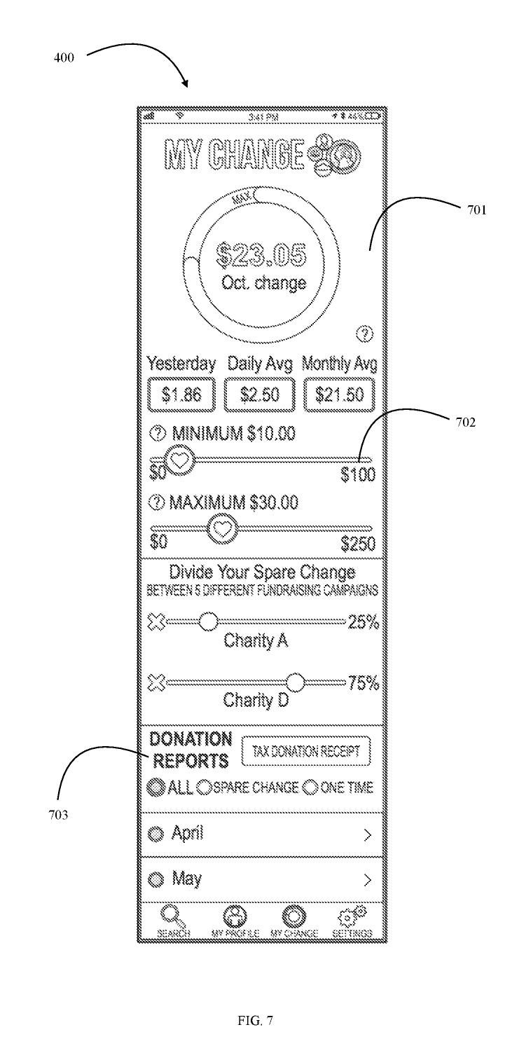

In an embodiment and in specific reference to FIG. 7, metrics 701 related to charitable giving are displayed. This may be viewed by selecting a tab, such as a “My Change” tab. Any number of metrics known in the arts may be displayed including daily, weekly, monthly, yearly, or total donations. The system may also calculate averages, among other useful analytics for any timeframe.

In an embodiment, the user may elect minimum and maximum donation amounts for a user-specified period of time by utilizing a donation tab 702, or similar implement. The system records donations and ensures that a predetermined minimum is met. If total donations for the predetermined time period are not met, the system will automatically donate the remainder to reach the minimum. In an example, a user specifies a minimum of $100 in donations for the month, however, change totals equal $80. The system will extract an additional $20 to reach the specified monthly minimum. On the contrary, the user may specify a maximum, such that donations over the predetermined maximum are not made.

In an embodiment, notifications may be sent to the PED to alert the user of minimum and maximum donations. As known in the arts, the system may alert the user of each donation, or alert at user-determined intervals to notify the user of specific donation amounts, and allocations thereof.

In a preferred embodiment, the user may allocate donations to a plurality of charity campaigns. In an example, the user may elect to donate 25% to a first charity (“Charity A”) and 75% to a second charity (“Charity B”).

In an embodiment, the system may generate tax reports 703 as known in the arts. Preferentially, these are generated at specified time intervals, such as monthly. Reports may be tabulated for the user to access at any time.

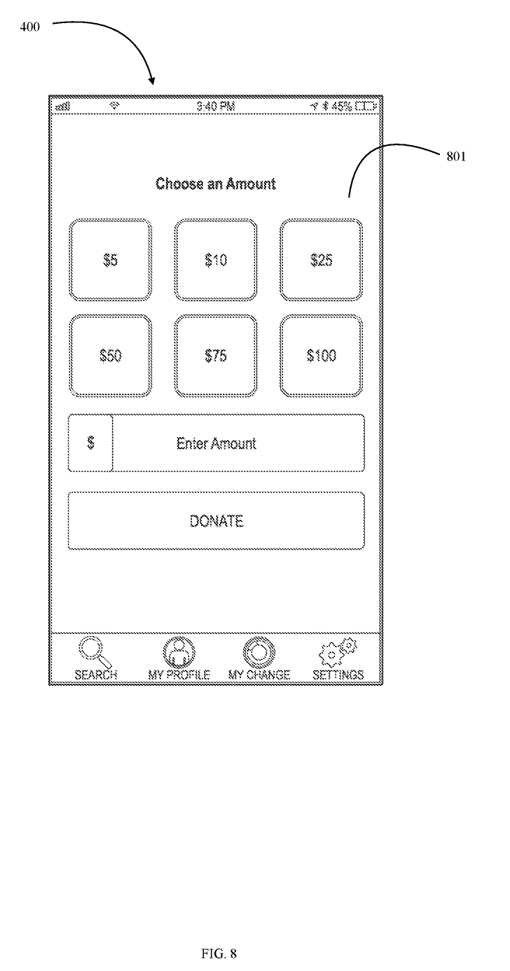

In reference to FIGS. 8-10 the user may also elect to make single donations to any number of charities. An amount may be selected from a list of common donation amounts 801, or specifically entered. If a custom amount is desired, the system uploads a numeric table for the user to input the amount.

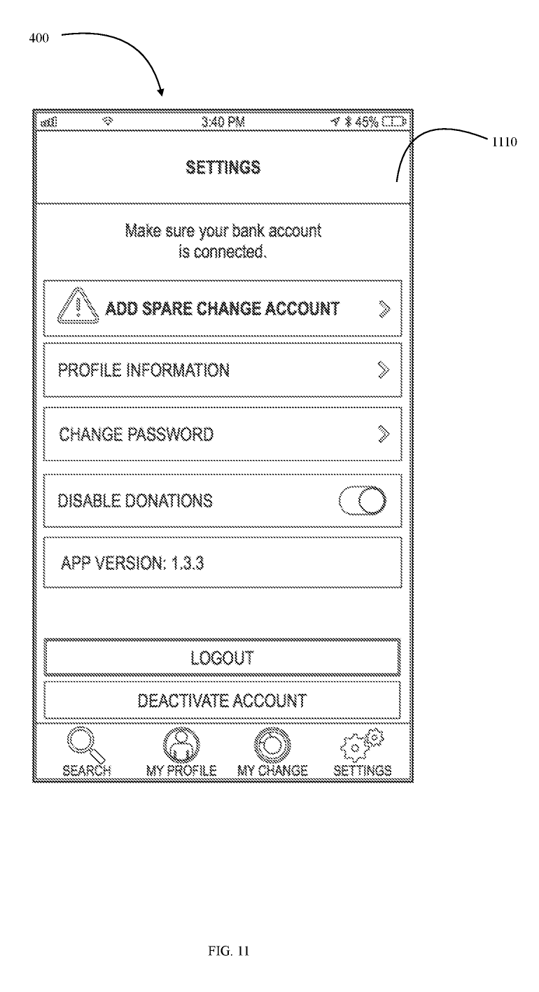

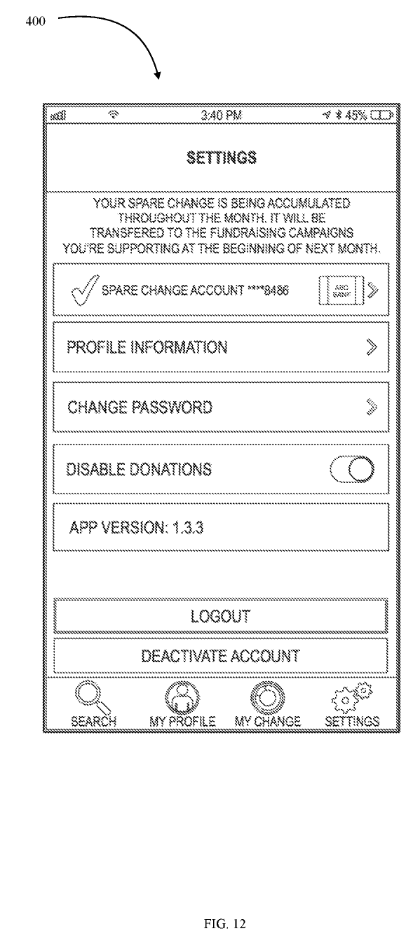

In reference to FIG. 11 and FIG. 12, the user may modify account settings 1110 commonly known in the arts including payment information, profile information, security credentials, as well as enabling and disabling donations.

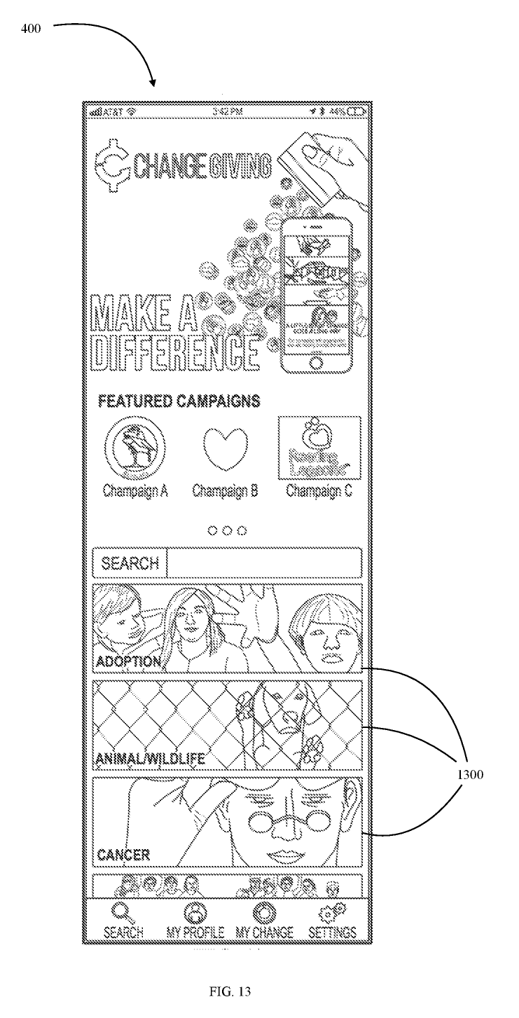

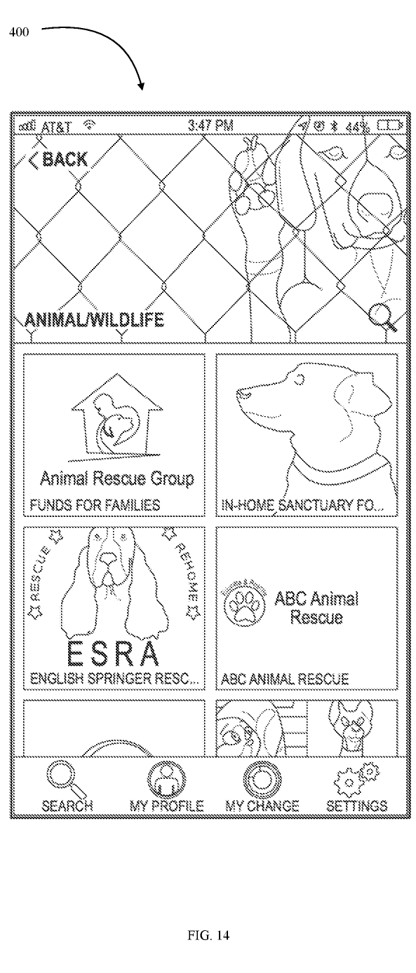

FIG. 13 illustrates the GUI 400 having a list of featured campaigns as well as searchable campaign categories. For example, a user may select from a list of categories 1300 including “adoption”, “animal/wildlife”, “cancer”, among other categories of charities. Each charity category 1300 may be selected to expand a list of charities within the selected category (seen in FIG. 14). As an example, FIG. 14, illustrates the GUI 400 having a list of specific charities within the selected category in FIG. 13. Selection of a specific charity as shown in FIG. 14 may lead the user to the charity interface illustrated illustrated in FIG. 5, wherein the user may elect to donate specific amounts to the charity at user-determined time intervals.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for user-directed donations to a plurality of charities comprising;
a processor;
a graphical user interface in communication with the processor; and
at least one storage device in communication with the processor via at least one network, wherein the processor is adapted to communicate with the at least one storage device and the user interface to execute instructions to perform the following:
registering a user account;
associating the user account with a user;
linking a user financial account with a user account;
calculating, utilizing the processor, a monetary value for a transaction in the user financial account;
calculating, utilizing the processor, a monetary difference between the monetary value and the next largest whole integer amount;
sending, utilizing the processor, the monetary difference to a user-specific charity financial account;
associating, utilizing the processor, the monetary difference with a user account; and
adding the monetary difference to a balance in a user account.

2. The system of claim 1, further comprising the step of selecting, by the user, a plurality of recipients to send the monetary difference.

3. The system of claim 2, further comprising the step of selecting, by the user, a percentage of each monetary difference to send to each of the plurality of recipients.

4. The system of claim 1, wherein the monetary difference from a plurality of transactions in the user financial account are calculated to form a periodic donation at a time interval.

5. The system of claim 1, wherein a single donation may be selected by the user.

6. The system of claim 1, wherein the network quantifies donations and displays the quantified donations on the graphical user interface.

7. The system of claim 1, wherein the network is configured to coordinate transfer of a plurality of monetary donations between a donor and the recipient.

8. The system of claim 1, wherein the network provides means for the user to set a maximum and a minimum donation sum.

9. The system of claim 1, wherein the network provides one or more tax summaries.

10. The system of claim 1, wherein the user may modify its selected charities at any time for future monetary values.

11. The system of claim 1, wherein the user may modify its selected percentage for each monetary difference at any time for future monetary values.

12. The system of claim 1 further comprising the step of storing information in the at least one storage devices relating to donations directed to charities on behalf of the user.

13. The system of claim 1 further comprising the step of verifying, by an administrator, the user account.

14. A method for directing user donations, the method comprising the steps of:
receiving at a processor over a network a user's selection of a plurality of recipients;
receiving at a processor over a network a user's selection of donation percentages for each of the plurality of recipients;
storing, by at least one storage device a plurality of financial transactions;
calculating a monetary difference between each financial transaction amount and the next largest whole integer amount;
apportioning, dependent on the selected plurality of recipients and selected donation percentages thereof, a donation sum;
associating the donation sum with the user account; and
distributing the donation sum to the selected plurality of charities at a time interval.

15. The system of claim 14 including the step of selecting, by the user, a maximum donation sum and a minimum donation sum.

16. The system of claim 14 having a user account module, a charity account module, a donation tracking module, and a transaction tracking module.

17. The system of claim 14 wherein the user account module performs the steps of:
communicating with a user's personal electronic device;
registering the user;
permitting the user to select the plurality of charities; and
permitting the user to select the donation percentages for each of the selected plurality of charities.

18. The system of claim 14 wherein the charity account module performs the steps of:
communicating with the charities personal electronic device;
communicating with a charity's personal electronic device;
registering the charity; and
permitting the charity to receive donations.

19. The system of claim 14 wherein the transaction tracking module performs the step of tracking a plurality of transactions in a user financial account.

20. The system of claim 14 wherein the donations tracking module performs the steps of:
tracking donations made throughout the network; and
associating donations with the user.
